(19) United States
(12) Patent Application Publication
(10) Pub. No.: US 2020/0352201 A1
(43) Pub. Date: Nov. 12, 2020

(54) METHOD OF VACUUM MARINATING MEAT WITH PEROXYCARBOXCYLIC ACID SOLUTIONS

(71) Applicant: ZEE COMPANY, INC., Chattanooga, TN (US)

(72) Inventors: Robert C. Bullard, Signal Mountain, TN (US); Jonathon R. Bullard, Chattanooga, TN (US); James A. Faller, Chattanooga, TN (US)

(21) Appl. No.: 16/868,071

(22) Filed: May 6, 2020

Related U.S. Application Data
(60) Provisional application No. 62/843,956, filed on May 6, 2019.

(51) Int. Cl. A23L 13/70; A23L 13/40

(52) U.S. Cl. CPC A23L 13/72; A23L 13/428; A23V 2300/31; A23V 2250/02; A23V 2002/00

(57) ABSTRACT

A method for producing a marinated meat product having an extended shelf life and/or reduced microbial activity by vacuum tumbling meat pieces in the presence of at least one peroxycarboxylic acid. The meat pieces may be treated with the desired marinade at the same time as being treated with the at least one peroxycarboxylic acid or separately. The marinated meat pieces may be packaged in the presence of at least one peroxycarboxylic acid to extend the shelf-life of the marinated meat product.

### CROSS-REFERENCE TO RELATED APPLICATIONS

The present application claims the benefit of U.S. Provisional Application No. 62/843,956 filed May 6, 2019, which is hereby incorporated herein in its entirety by reference.

### FIELD OF THE INVENTION

The present invention relates to a method of processing a food product, more particularly vacuum marinating, vacuum brining and/or vacuum barbequing meats in the presence of a marinade, brine or barbeque sauce and a peroxycarboxylic acid solution, to provide a marinated meat product, such as marinated red meat, poultry, pork, fish or seafood.

### BACKGROUND OF THE INVENTION

The world population has grown to point where mass production of the foods that we consume is no longer a luxury but a requirement. Local farmers, providing food and food products directly to the marketplace, cannot meet the demands of modern society. The food supply chain now incorporates very large, complex farms and high speed and very high volume processing plants to satisfy the need for mass processing and production of food. Maintaining a safe food supply chain relies on the dedication of those working in the supply chain, the processing plants and also on the third party oversight of various Federal agencies whose regulations support and mandate food safety.

Steeping or soaking meats in a marinade, brine, barbeque sauce (“marinade”) has long become a preferred step in preparing and cooking meats that are moist, flavorful and tender. Marinating has also been used to extend the shelf life of meats using salts, spices and acids, such as vinegar. The meat processing industry has recognized these characteristics can be improved by vacuum tumbling the meat in the presence of a marinade. Reducing pressure by application of a vacuum in the presence of a marinade is believed to expand and remove the gases located in the interstitial spaces within the meat and assists in effecting the absorption of the marinade into the meat. The application of a vacuum is also believed to help mechanically distort the meat by expanding it, which assists in the breakdown of the meat fibers to enhance tenderization. The marinade typically contains tenderizing agents, flavoring agents, as well as moisture, and thus the absorption of the marinade into the meat further enhances the moisture content, the tenderization, and the flavoring of the meat. When the drum of a vacuum tumbler rotates, the meat is infused with liquid instead of air due to the different atmospheric pressure and vacuum pressure. While marinating meat will reduce the oxidation process, extend the deterioration process, and may have some antimicrobial properties that result in a longer shelf life compared to meat that has not been marinated, marinated meats must still be consumed or frozen in a timely manner to avoid microbial contamination.

The use of antimicrobial agents on red meat has been implemented to control microbial growth. PAA, which is also sometimes called peracetic acid or peroxyacetic acid, is a peroxycarboxylic acid and is a well known chemical for its strong oxidizing potential, has the molecular formula CH₃COOOH, and has a molecular structure as follows:

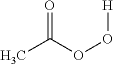

An equilibrium peroxyacetic acid solution is produced from an equilibrium mixture of hydrogen peroxide, acetic acid and water (“equilibrium PAA solution”), which often uses an acid catalyst, e.g., sulfuric acid.

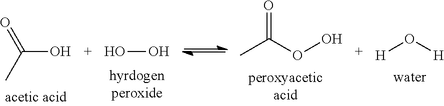

As a peroxoyacetic acid solution interacts with an organic load, the peroxyacetic acid solution converts to acetic acid and water.

The methods of the present invention improve upon prior methods of marinating meat by producing marinated meats that have an extended shelf life compared to meats that have not been marinated and also over meats that have been vacuum tumbled in the presence of a marinade. Furthermore, the present invention allows the process of marinating to be accomplished by a single, in-line industrial method without the need to be completed in batches, and continue to use traditional vacuum tumbling marinating techniques.

### SUMMARY OF THE INVENTION

In some aspects of the present invention, a process for producing marinated meat products having an extended shelf life and/or reduced microbial activity vacuum comprises vacuum tumbling meat pieces that are desirable of being marinated in the presence of a marinade and at least one peroxycarboxylic acid solution. In some aspects, the meat pieces are treated with the marinade and the at least one peroxycarboxylic acid solution in a vacuum tumbler at the same time. In some aspects, the meat pieces are treated with the marinade and the at least one peroxycarboxylic acid solution in a vacuum tumbler at separate times.

In some aspects of the present invention, a method for marinating meat products includes treating meat pieces in a vacuum tumbler under reduced pressure with a marinade in the presence of a peroxycarboxylic acid solution for a desired period of time.

In some aspects of the present invention, a method of marinating a meat product includes placing meat pieces, a desired marinade and at least one peroxycarboxylic acid in a tumbling container of a vacuum tumbler, reducing the pressure within the tumbling container to vacuum pressure, rotating the meat pieces within the marinade and at least one peroxycarboxylic acid under vacuum for a desired period of time, and returning the pressure within the tumbling container to atmospheric pressure to provide a marinated meat product. In some aspects, the marinated meat product is removed from the tumbling container and packaged for later consumer use of cooking and consumption. In some aspects, the marinated meat product is ground with any remaining marinade solution prior to packaging.

In some aspects of the present invention, a method of marinating a meat product includes placing meat pieces in a tumbling container of a vacuum tumbler and at least one peroxycarboxylic acid, reducing the pressure within the tumbling container to bring the contents of the tumbling container to vacuum pressure, rotating the meat pieces in the presence of at least one peroxycarboxylic acid under vacuum pressure for a desired period of time, returning the pressure of the tumbling container to atmospheric pressure, adding a marinade to the tumbling container, reducing the pressure within the tumbling container to bring the contents of the tumbling container to vacuum pressure, rotating the meat pieces in the presence of the marinade under vacuum pressure for a desired period of time, and returning the pressure within the tumbling container to atmospheric pressure to provide a marinated meat product. In some aspects, the contents of the tumbling container are drained after rotating the meat pieces in the presence of the at least one peroxycarboxylic acid under vacuum pressure and prior to addition of the marinade.

In some aspects of the present invention, the pressure is reduced to a pressure between about −0.1 psi up to about −15 psi, in some aspects between about −0.2 psi and about −12 psi, in some aspects between about −0.3 psi and about −10 psi, in some aspects between about −0.4 psi and about −5 psi, in some aspects between about −0.6 psi and about −2 psi, and in some other aspects between about −0.7 psi and about −1 psi. In some aspects, the interior pressure within the vacuum tumbler is alternated between at least two different vacuum pressure levels below atmospheric pressure.

In some aspects of the present invention, the meat pieces are rotated in the presence of the at least one peroxycarboxylic acid under vacuum pressure for at least 10 minutes and up to 60 minutes, in some aspects between about 12 minutes and about 50 minutes, in some aspects between about 15 minutes and about 45 minutes, in some aspects between about 18 minutes and about 30 minutes, and in some other aspects between about 20 minutes and about 25 minutes.

In some aspects of the present invention, the at least one peroxycarboxylic acid has between about 2 to 12 carbon atoms. In some aspects, the peroxycarboxylic acid is an equilibrium peroxycarboxylic acid solution, while in some other aspects the peroxycarboxylic acid is a pH modified peroxycarboxylic acid solution. In some aspects, the peroxycarboxylic acid solution is chosen from peroxyformic, peroxypropionic, peroxyacetic, peroxybutanoic, peroxypentanoic, peroxyhexanoic, peroxyheptanoic, peroxyoctanoic, peroxynonanoic, peroxydecanoic, peroxyundecanoic, peroxydodecanoic, peroxylactic, peroxymaleic, peroxyascorbic, peroxyhydroxyacetic, peroxyoxalic, peroxymalonic, peroxysuccinic, peroxyglutaric, peroxyadipic, peroxypimelic, peroxysubric acid, peroxycitric acid, and mixtures thereof. In some aspects, the peroxycarboxylic acid solution is peroxyacetic acid and peroxylactic acid, in some aspects peroxyacetic acid, and in some other aspects peroxylactic acid.

In some aspects, the concentration of the at least one peroxycarboxylic acid in the tumbling container is at least about 5 ppm, in some aspect at least about 10 ppm, in some aspects at least about 15 ppm, and in some other aspects at least about 20 ppm. In some aspects, the concentration of the at least one peroxycarboxylic acid in the tumbling container is up to about 50 ppm, in some aspects up to about 100 ppm, in some aspects up to about 250 ppm, in some aspects up to about 500 ppm. In some aspects, the concentration of the at least one peroxycarboxylic acid in the tumbling container is between about 10 ppm and about 500 ppm, in some aspects between about 12 ppm and about 250 ppm, in some aspects between about 15 ppm and about 150 ppm, in some aspects between about 20 ppm and about 100 ppm, in some aspects between about 25 ppm and about 75 ppm, and in some other aspects between about 30 ppm and about 50 ppm.

In some aspects, the equilibrium peroxycarboxylic acid has a pH above about 3.0 and below about 7.0, in certain aspects a pH range of about 3.5 to about 5.5, and in some other aspects a pH range of about 3.5 to about 5.0.

In some aspects, the intervention solution comprises a pH modified peroxycarboxylic acid. In some aspects, the pH modified peroxycarboxylic acid has a pH above about 7.0 and below about 10.0, in certain aspects a pH range of about 7.0 to about 9.5, and in some other aspects a pH range of about 7.5 to about 9.0. In certain aspects of the present invention, the pH modified peroxycarboxylic acid is prepared using at least one buffering agent, said at least one buffering agent chosen from sodium hydroxide, potassium hydroxide, sodium salts of carbonic acid, potassium salts of carbonic acid, phosphoric acid, silicic acid and combinations thereof.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

The present invention can be better understood in consideration of the following detailed description of various embodiments of the invention in connection with the accompanying drawings, in which:

FIG. 1 is a flow diagram of the process of marinating meat pieces to produce marinated meat products according to certain aspects of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The term “marinade” as used herein refers to a seasoned liquid in which meat, such as red meat, poultry, pork, fish or seafood, is soaked to enrich the flavor of the meat and/or tenderize the meat. Such seasoned liquids include brines, barbeque sauces, acidic marinades (made with ingredients such as vinegar, lemon juice or wine), enzymatic marinades (made with ingredients such as pineapple, papaya or ginger), and the like.

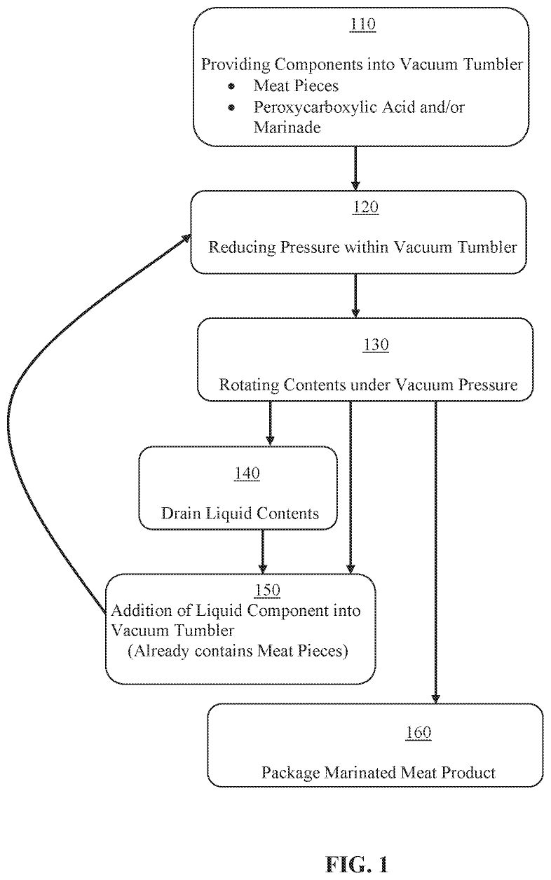

The present invention is directed to a process of providing a marinated meat product from meat pieces in the presence of a marinade and at least one peroxycarboxylic acid. Referring generally to FIG. 1, the process generally comprises providing components into a vacuum container of a vacuum tumbler 110. The components may include meat pieces that are desirable of being marinated and at least one peroxycarboxylic acid, the desired marinade or both. The vacuum container is then closed and the pressure is reduced within the vacuum tumbler 120 to provide vacuum pressure. The contents of the vacuum tumbler are then rotated while under the vacuum pressure for a desired period of time 130. When the drum of a vacuum tumbler rotates, the meat pieces within the vacuum container are infused with liquid instead of air due to the different atmospheric pressure and vacuum pressure. Once the vacuum tumbling is completed, the marinated meat product may be packaged 160.

In some alternative aspects, such as when only the at least one peroxycarboxylic acid or the desired marinade is initially provided into the vacuum container for vacuum tumbling of the contents, the liquid contents of the vacuum container may be drained or removed 140 before additional liquid contents are added into the vacuum container 150, followed by repeating the process steps of pressure reduction 120 and rotation under vacuum pressure 130.

In still another alternative aspect, additional liquid contents may be added into the vacuum container 150 without the removal of any liquid contents, followed by repeating the process steps of pressure reduction 120 and rotation under vacuum pressure 130.

In a preferable process of producing marinated meat products, the meat pieces that are desirable of being marinated are provided into a vacuum container of the vacuum tumbler with both the desired marinade and at least one peroxycarboxylic acid solution 110. The pressure of the vacuum container containing the meat pieces, marinade and at least one peroxycarboxylic acid is then reduced to provide vacuum pressure 120. The contents of the vacuum tumbler are then rotated while under the vacuum pressure for a desired period of time 130. Once the vacuum tumbling is completed, the marinated meat product may be packaged 160.

In some aspects, the liquid contents of the vacuum container may be drained or removed 140 before additional liquid contents are added into the vacuum container 150, followed by repeating the process steps of pressure reduction 120 and rotation under vacuum pressure 130. For instance, the initial vacuum tumbling comprising the marinade and at least one peroxycarboxylic acid may be followed by the addition of another mixture of the marinade and at least one peroxycarboxylic acid components or one of the components alone before the steps of pressure reduction 120 and rotation under vacuum pressure 130 are repeated. Alternatively, the liquid contents may not be drained but instead remain in the vacuum tumbler when another mixture of the marinade and at least one peroxycarboxylic acid components or one of the components alone is added to the vacuum tumbler before the steps of pressure reduction 120 and rotation under vacuum pressure 130 are repeated.

In some aspects, the meat pieces are treated with the marinade and the at least one peroxycarboxylic acid solution in a vacuum tumbler at separate times. For instance, the at least one peroxycarboxylic acid may be initially provided in step 110 with the meat pieces, which then undergoes the steps of pressure reduction 120 and rotation under vacuum pressure 130, with the marinade being added in step 150, followed by repeating the steps of pressure reduction 120 and rotation under vacuum pressure 130. In another representative aspect, the marinade may be initially provided in step 110 with the meat pieces, which then undergoes the steps of pressure reduction 120 and rotation under vacuum pressure 130, with the at least one peroxycarboxylic acid being added in step 150, followed by repeating the steps of pressure reduction 120 and rotation under vacuum pressure 130.

Following the rotation of the contents under vacuum pressure 130, the pressure of the tumbling container is returned to atmospheric pressure to provide the marinated meat product. In some aspects, the marinated meat product is removed from the tumbling container and packaged 160 for later consumer use of cooking and consumption. In some alternative aspects, the meat product may be ground after the liquid contents are drained 140 and then packaged 160. In yet some alternative aspects the meat product and the liquid contents may be subjected to a grinding process prior to being packaged 160.

The pressure of the vacuum container can be reduced to a pressure between about −0.1 psi up to about −15 psi, in some aspects between about −0.2 psi and about −12 psi, in some aspects between about −0.3 psi and about −10 psi, in some aspects between about −0.4 psi and about −5 psi, in some aspects between about −0.6 psi and about −2 psi, and in some other aspects between about −0.7 psi and about −1 psi.

The meat pieces are rotated under vacuum pressure in the presence of the at least one peroxycarboxylic acid under vacuum pressure for at least 10 minutes and up to 60 minutes, in some aspects between about 12 minutes and about 50 minutes, in some aspects between about 15 minutes and about 45 minutes, in some aspects between about 18 minutes and about 30 minutes, and in some other aspects between about 20 minutes and about 25 minutes.

The meat pieces are rotated under vacuum pressure in the presence of the marinade under vacuum pressure for at least 10 minutes and up to 60 minutes, in some aspects between about 12 minutes and about 50 minutes, in some aspects between about 15 minutes and about 45 minutes, in some aspects between about 18 minutes and about 30 minutes, and in some other aspects between about 20 minutes and about 25 minutes.

In preferably aspects of the meat pieces being rotated under vacuum pressure in the presence of both the at least one peroxycarboxylic acid and marinade, the treatment of the meat pieces under vacuum pressure occurs for at least 10 minutes and up to 60 minutes, in some aspects between about 12 minutes and about 50 minutes, in some aspects between about 15 minutes and about 45 minutes, in some aspects between about 18 minutes and about 30 minutes, and in some other aspects between about 20 minutes and about 25 minutes.

In other preferable aspects of the meat pieces being rotated under vacuum pressure in the presence of the at least one peroxycarboxylic acid and marinade separately, the treatment of the meat pieces under vacuum pressure in the presence of the at least one peroxycarboxylic acid occurs for at least 10 minutes and up to 60 minutes, in some aspects between about 12 minutes and about 50 minutes, in some aspects between about 15 minutes and about 45 minutes, in some aspects between about 18 minutes and about 30 minutes, and in some other aspects between about 20 minutes and about 25 minutes, and the treatment of the meat pieces under vacuum pressure in the presence of the marinade occurs for at least 10 minutes and up to 60 minutes, in some aspects between about 12 minutes and about 50 minutes, in some aspects between about 15 minutes and about 45 minutes, in some aspects between about 18 minutes and about 30 minutes, and in some other aspects between about 20 minutes and about 25 minutes.

In some aspects, the interior pressure within the vacuum container is alternated between at least two different vacuum pressure levels below atmospheric pressure. For instance, the pressure of the vacuum container can be alternated between a first vacuum pressure between about −0.7 psi and about −1 psi and a second vacuum pressure between about −0.2 psi and about −0.5 psi. In some aspects, the vacuum container is alternated between the first vacuum pressure and the second vacuum pressure after about 30 seconds up to about 10 minutes, in some aspects after about 1 minute up to about 10 minutes, and in some aspects after about 2 minutes and up to about 5 minutes. Without wishing to be bound by theory, it is believed that the alternation of pressures below atmospheric pressure has a pulsating action of providing the marinade and at least one peroxycarboxylic acid into the meat pieces.

The at least one peroxycarboxylic acid has between about 2 to 12 carbon atoms. In some aspects, the peroxycarboxylic acid is an equilibrium peroxycarboxylic acid solution, while in some other aspects the peroxycarboxylic acid is a pH modified peroxycarboxylic acid solution. In some aspects, the peroxycarboxylic acid solution is chosen from peroxyformic, peroxypropionic, peroxyacetic, peroxybutanoic, peroxypentanoic, peroxyhexanoic, peroxyheptanoic, peroxyoctanoic, peroxynonanoic, peroxydecanoic, peroxyundecanoic, peroxydodecanoic, peroxylactic, peroxymaleic, peroxyascorbic, peroxyhydroxyacetic, peroxyoxalic, peroxymalonic, peroxysuccinic, peroxyglutaric, peroxyadipic, peroxypimelic, peroxysubric acid, peroxycitric acid, and mixtures thereof. In some aspects, the peroxycarboxylic acid solution is peroxyacetic acid and peroxylactic acid, in some aspects peroxyacetic acid, and in some other aspects peroxylactic acid.

The concentration of the at least one peroxycarboxylic acid in the tumbling container is at least about 5 ppm, in some aspect at least about 10 ppm, in some aspects at least about 15 ppm, and in some other aspects at least about 20 ppm. In some aspects, the concentration of the at least one peroxycarboxylic acid in the tumbling container is up to about 50 ppm, in some aspects up to about 100 ppm, in some aspects up to about 250 ppm, in some aspects up to about 500 ppm. In some aspects, the concentration of the at least one peroxycarboxylic acid in the tumbling container is between about 10 ppm and about 500 ppm, in some aspects between about 12 ppm and about 250 ppm, in some aspects between about 15 ppm and about 150 ppm, in some aspects between about 20 ppm and about 100 ppm, in some aspects between about 25 ppm and about 75 ppm, and in some other aspects between about 30 ppm and about 50 ppm.

The peroxycarboxylic acid is preferably provided in the tumbling container as an equilibrium peroxycarboxylic acid having a pH above about 3.0 and below about 7.0, in certain aspects a pH range of about 3.5 to about 5.5, and in some other aspects a pH range of about 3.5 to about 5.0.

The peroxycarboxylic acid may alternatively be provided in the tumbling container as a pH modified peroxycarboxylic acid. In some aspects, the pH modified peroxycarboxylic acid has a pH above about 7.0 and below about 10.0, in certain aspects a pH range of about 7.0 to about 9.5, and in some other aspects a pH range of about 7.5 to about 9.0. In certain aspects of the present invention, the pH modified peroxycarboxylic acid is prepared using at least one buffering agent, said at least one buffering agent chosen from sodium hydroxide, potassium hydroxide, sodium salts of carbonic acid, potassium salts of carbonic acid, phosphoric acid, silicic acid and combinations thereof.

The at least one peroxycarboxylic acid applied in the present process result in at least a 60% bacterial count reduction, in some aspects at least a 70% bacterial count reduction, in some aspects at least an 80% bacterial count reduction, in some aspects at least a 90% bacterial count reduction, and in some aspects at least a 95% bacterial count reduction, compared to the same meat product treated with just the marinade.

The process of providing meat products may result in at least a 3 day and up to 14 day extension of the shelf life of the marinated food product compared to the same meat product treated with just the marinade. In some aspects, the extended shelf life of the marinated meat product is between at least 3 days and 10 days.

In some aspects, the marinade comprises at least one salt component chosen from sodium chloride, potassium chloride, and mixtures thereof. In some aspects, the marinade comprises a phosphate selected from potassium phosphate, sodium phosphate, and mixtures thereof.

In some aspects, the marinade comprises one or more of vinegar components. The vinegar component may comprise white wine vinegar, balsamic vinegar, rice vinegar, red wine vinegar, white wine vinegar, black vinegar, champagne, distilled white vinegar, coconut vinegar, apple cider vinegar, malt vinegar, sugar cane vinegar, and combinations thereof.

In some aspects, the marinade is devoid of a vinegar component. In some aspects, the peroxycarboxylic acid forms the vinegar component in the marinade as the peroxycarboxylic acid solution converts to the carboxylic acid and water. In some aspects, the peroxycarboxylic acid forms at least part of the vinegar in the marindate as the peroxycarboyxlic acid converts to the carboxylic acid and water. In some aspects, the peroxycarboxylic acid comprises peroxyacetic acid, peroxylactic acid, or a combination thereof, that converts to acetic acid, lactic acid, or a combination thereof, and water to comprise at least a portion of the vinegar component in the marinade.

In some aspects, the marinade comprises one or more flavoring agents. Exemplary flavoring agents include red wine, white wine, champagne, pineapple, papaya, ginger, brown sugar, olive oil, sesame oil, canola oil, sunflower oil, vegetable oil, sea salt, kosher salt, black pepper, red pepper, garlic, onion, soy sauce, lime juice, lime zest, lemon juice, lemon zest, orange juice, orange zest, tomato juice, tomato paste, tomato powder, mustard, cumin, oregano, parsley, thyme, rosemary, honey, molasses, hoisin sauce, high fructose corn syrup, cane sugar, beet sugar, or combinations thereof.

In some aspects, the meat product is chosen from chicken, beef, pork, lamb, bison, duck, turkey, shell fish, fish and mixtures thereof.

The process of providing marinated meat products may be a batch process or a continuous process. In a continuous process, meat pieces are continually fed into the vacuum tumbler with a liquid source comprising the marinade and the at least one peroxycarboxylic acid being continuously added to maintain a specified volume and concentration. The amount of the liquid source comprising the marinade and the at least one peroxycarboxylic acid added that is added is preferably about equal to the amount removed with the marinated meat products. The contents within the vacuum container may be periodically removed and replaced with a fresh source of the marinade and at least one peroxycarboxylic acid.

### EXAMPLES

### Example 1—Vacuum Infusing Boneless Poultry Parts

Samples of poultry in an amount of about 1 pound were prepared from boneless poultry parts. Each sample was provided in a vacuum container of a vacuum tumbler in the presence of the antimicrobial solution (peroxyacetic acid (“PAA”) or peroxylactic acid (“PLA”)) provided in Table 1, with the control subjected to the same volume of sterile water. The pressure was reduced in the vacuum tumbler to about −0.4 bar, and the contents were rotated in the vacuum-tumbler while under pressure for a period of time of about 15 minutes. Pressure was then returned to atmospheric pressure and the contents of the vacuum container were subjected to grinding and then stored in a sealed plastic bag at about 4° C. The ground product was evaluated daily for appearance and order until reaching failure by abnormal coloration and/or odor. The Control and each microbial concentration sample was performed in duplicate, with the first date of organoleptic failure for the duplicate samples reported in Table 1.

TABLE 1
Vacuum-Infusing Boneless Poultry Parts.

| Antimicrobial | Concentration (ppm) | Days to Organoleptic Failure |
|---|---|---|
| None - Control | 0 | 5 |
| PAA | 100 | 11 |
| PLA | 100 | 11 |
| PAA | 250 | 13 |
| PLA | 250 | 14 |
| PAA | 500 | 17 |
| PLA | 500 | 16 |
| PAA | 1000 | 19 |
| PLA | 1000 | 19 |

The untreated grind was rancid and discolored by day 5 while many of the treated grinds did not show signs of significant degradation until day 18, where color started to deteriorate. By day 21, all samples had reached failure for both organoleptics evaluated. The organoleptic shelf-life provided by the data in Table 1 indicates that a marinade having as little as 100 ppm of the peroxycarboxylic acid will nearly double the shelf-life of the ground poultry product. When the peroxycarboxylic acid concentration is increased to 250, 500 and 1000 ppm the shelf-life is further extended to nearly three and four times that of untreated poultry product. Since grinding meat products results in higher microbial exposure to the meat product, it is anticipated that unground poultry products subjected to the vacuum-infusion with the peroxycarboxylic acid will result in an even longer shelf-life. It is also anticipated that vacuum-infusion of poultry product with both the peroxycarboxylic acid and marinade solution, whether together or serially, will have an even longer shelf-life due to the natural preservation effects of components in marinade solutions.

### Example 2—Vacuum Infusing Boneless Beef Parts

Samples of beef in an amount of about 1 pound were prepared from boneless beef parts. Each sample was provided in a vacuum container of a vacuum tumbler in the presence of the antimicrobial solution (peroxyacetic acid (“PAA”) or peroxylactic acid (“PLA”)) provided in Table 2, with the control subjected to the same volume of sterile water. The pressure was reduced in the vacuum tumbler to about −0.4 bar, and the contents were rotated in the vacuum-tumbler while under pressure for a period of time of about 15 minutes. Pressure was then returned to atmospheric pressure and the contents of the vacuum container were subjected to grinding and then stored in a sealed plastic bag at about 4° C. The ground product was evaluated daily for appearance and order until reaching failure by abnormal coloration and/or odor. The Control and each microbial concentration sample was performed in duplicate, with the first date of organoleptic failure for the duplicate samples reported in Table 1.

TABLE 2
Vacuum-Infusing Boneless Beef Parts.

| Antimicrobial | Concentration (ppm) | Days to Organoleptic Failure |
|---|---|---|
| None - Control | 0 | 7 |
| PAA | 100 | 11 |
| PLA | 100 | 11 |
| PAA | 250 | 13 |
| PLA | 250 | 13 |
| PAA | 500 | 15 |
| PLA | 500 | 15 |
| PAA | 1000 | 17 |
| PLA | 1000 | 17 |

The untreated grind was rancid and discolored by day 7 while many of the treated grinds did not show signs of significant degradation until day 17, where color started to deteriorate. By day 21, all samples had reached failure for both organoleptics evaluated. The organoleptic shelf-life provided by the data in Table 2 indicates that a marinade having as little as 100 ppm of the peroxycarboxylic acid will nearly double the shelf-life of the ground beef product. When the peroxycarboxylic acid concentration is increased to 250, 500 and 1000 ppm the shelf-life is further extended to nearly three and four times that of untreated beef product. Since grinding meat products results in higher microbial exposure to the meat product, it is anticipated that unground beef products subjected to the vacuum-infusion with the peroxycarboxylic acid will result in an even longer shelf-life. It is also anticipated that vacuum-infusion of beef product with both the peroxycarboxylic acid and marinade solution, whether together or serially, will have an even longer shelf-life due to the natural preservation effects of components in marinade solutions.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A method for producing a marinated meat product, the method comprising:
providing one or more pieces of meat in a vacuum container of a vacuum tumbler in the presence of a solution comprising at least one peroxycarboxylic acid, a desired marinade having one or more flavoring components, or a mixture of the least one peroxycarboxylic acid solution and the desired marinade;
reducing the pressure of the vacuum tumbler to provide the contents of the vacuum container under a vacuum pressure between about −0.1 psi up to about −15 psi;
rotating the contents of the vacuum container while under the vacuum pressure for a desired period of time of at least 10 minutes and up to 60 minutes to vacuum tumble the one or more pieces of meat and provide the marinated meat product.

2. The method for producing a marinated meat product of claim 1, wherein the one or more pieces of meat are vacuum tumbled in the presence of both the at least one peroxycarboxylic acid solution and the desired marinade at the same time.

3. The method for producing a marinated meat product of claim 1, wherein the one or more pieces of meat are vacuum tumbled in the presence of the at least one peroxycarboxylic acid solution and the desired marinade at separate times.

4. The method for producing a marinated meat product of claim 3, wherein the one or more pieces of meat are vacuum tumbled in the presence of the at least one peroxycarboxylic acid solution prior to the desired marinade being provided to the vacuum container.

5. The method for producing a marinated meat product of claim 3, wherein the one or more pieces of meat are vacuum tumbled in the presence of the desired marinade prior to the at least one peroxycarboxylic acid solution being provided to the vacuum container.

6. The method for producing a marinated meat product of claim 1, further comprising grinding the marinated meat product.

7. The method for producing a marinated meat product of claim 1, further comprising packaging the marinated meat product.

8. The method for producing a marinated meat product of claim 1, wherein the vacuum pressure is between about −0.4 psi and about −5 psi.

9. The method for producing a marinated meat product of claim 1, wherein the desired period of time of rotating the contents of the vacuum container while under the vacuum pressure is at least 10 minutes and up to 60 minutes.

10. The method for producing a marinated meat product of claim 9, wherein the meat pieces are rotated in the presence of the desired marinade while under the vacuum pressure for at least 15 minutes and up to about 45 minutes.

11. The method for producing a marinated meat product of claim 9 wherein the meat pieces are rotated in the presence of the at least one peroxycarboxylic acid solution under the vacuum pressure for at least 15 minutes and up to about 45 minutes.

12. The method for producing a marinated meat product of claim 1, further comprising alternating the vacuum pressure between at least two different vacuum pressures during the step of rotating the contents of the vacuum container while under the vacuum pressure.

13. The method for producing a marinated meat product of claim 11, wherein a difference between the at least two different vacuum pressures is at least about 0.2 psi.

14. The method for producing a marinated meat product of claim 12, wherein a first vacuum pressure is between about −0.7 psi and about −1 psi and a second vacuum pressure is between about −0.2 psi and about −0.5 psi.

15. The method for producing a marinated meat product of claim 1, wherein the at least one peroxycarboxylic acid is chosen from peroxyformic, peroxypropionic, peroxyacetic, peroxybutanoic, peroxypentanoic, peroxyhexanoic, peroxyheptanoic, peroxyoctanoic, peroxynonanoic, peroxydecanoic, peroxyundecanoic, peroxydodecanoic, peroxylactic, peroxymaleic, peroxyascorbic, peroxyhydroxyacetic, peroxyoxalic, peroxymalonic, peroxysuccinic, peroxyglutaric, peroxyadipic, peroxypimelic, peroxysubric acid, peroxycitric acid, and mixtures thereof.

16. The method for producing a marinated meat product of claim 1, wherein the at least one peroxycarboxylic acid solution is an equilibrium peroxycarboxylic acid solution having a pH above about 3.0 and below about 7.0.

17. The method for producing a marinated meat product of claim 1, wherein the at least one peroxycarboxylic acid is a pH modified peroxycarboxylic acid solution having a pH above about 7.0 and below about 10.0.

18. The method for producing a marinated meat product of claim 1, wherein the at least one peroxycarboxylic acid is peroxyacetic acid, peroxylactic acid, or a mixture of peroxyacetic acid and peroxylactic acid.

19. The method for producing a marinated meat product of claim 1, wherein the at least one peroxycarboxylic acid is provided in the vacuum container at a concentration of at least about 10 ppm up to about 500 ppm.

20. The method for producing a marinated meat product of claim 1, wherein the marinade comprises a vinegar component chosen from balsamic vinegar, rice vinegar, red wine vinegar, white wine vinegar, black vinegar, champagne, distilled white vinegar, coconut vinegar, apple cider vinegar, malt vinegar, sugar cane vinegar, and combinations thereof.

21. The method for producing a marinated meat product of claim 1, wherein the one or more flavoring components is chosen fro red wine, white wine, champagne, pineapple, papaya, ginger, brown sugar, olive oil, sesame oil, canola oil, sunflower oil, vegetable oil, sea salt, kosher salt, black pepper, red pepper, garlic, onion, soy sauce, lime juice, lime zest, lemon juice, lemon zest, orange juice, orange zest, tomato juice, tomato paste, tomato powder, mustard, cumin, oregano, parsley, thyme, rosemary, honey, molasses, hoisin sauce, high fructose corn syrup, cane sugar, beet sugar, and combinations thereof.

22. The method for producing a marinated meat product of claim 1, wherein the one or more meat products is chosen from chicken, beef, pork, lamb, bison, duck, turkey, shell fish, fish and mixtures thereof.
